(19) United States
(12) Patent Application Publication
(10) Pub. No.: US 2026/0183985 A1
(43) Pub. Date: Jul. 2, 2026

(54) LOCATING A COMPOSITE PLY ON A LAYUP TOOL

(71) Applicant: The Boeing Company, Arlington, VA (US)

(72) Inventors: Erik Nicholas Wienhold, Seattle, WA (US); Brian James Smith, Seattle, WA (US); Sandra Louise Zmeu, Shoreline, WA (US); Christopher Robert Brown, Seattle, WA (US); Ricardo Andreas Fritzke, Sammamish, WA (US); Sangvavann Heng, Buena Park, CA (US); Michael J. Trowbridge, Long Beach, CA (US)

(21) Appl. No.: 19/005,039

(22) Filed: Dec. 30, 2024

(51) Int. Cl. B28B 17/00

(52) U.S. Cl. CPC B28B 17/0081; B28B 17/0036

(57) ABSTRACT

A ceramic matrix composite part and methods of locating a composite ply on a layup tool are presented. A composite ply comprising a fiducial is placed onto the layup tool. A position of the fiducial of the composite ply is determined relative to the layup tool. An actual position of the composite ply on the layup tool is determined. A difference between the actual position of the composite ply and a designed position for the composite ply is determined.

### STATEMENT OF GOVERNMENT INTEREST

This invention was made with Government support under contract number AFRL ManTech FA2394-23-C-B006 awarded by Department of Defense. The government has certain rights in this invention.

### BACKGROUND INFORMATION

### 1. Field

The present disclosure relates generally to composite manufacturing and more specifically to locating composite plies during composite manufacturing.

### 2. Background

Parts made of a fabric-based ceramic matrix composite (CMC) material are formed by building up multiple layers of CMC material on top of a layup mandrel or tool mold. In cases where the part edges are not trimmed, precision of edge placement directly affects quality of a finished part. Butt splices have overlap and gap tolerances, while overlapped plies have different tolerances, often within 0.050″ of nominal.

It is currently undesirably difficult to verify ply and boundary locations when the backing material is removed from the composite plies. Additionally, conventional methods utilize non-automated processes to locate edges and determine thicknesses, such as overhead laser tracers, depth cameras, and visible confirmation.

Therefore, it would be desirable to have a method and apparatus that takes into account at least some of the issues discussed above, as well as other possible issues. It would be desirable to provide a method of verifying ply locations during manufacturing.

### SUMMARY

An embodiment of the present disclosure provides a method of locating a composite ply on a layup tool. A composite ply comprising a fiducial is placed onto the layup tool. A position of the fiducial of the composite ply is determined relative to the layup tool. An actual position of the composite ply on the layup tool is determined. A difference between the actual position of the composite ply and a designed position for the composite ply is determined.

Another embodiment of the present disclosure provides a method of locating a composite ply on a layup tool. The method determines if a tool surface of the layup tool is curved. Based on a determination that the tool surface is curved, a ply shape is cut into a sheet of ceramic matrix composite material having a plurality of fiducials printed on a surface of the ceramic matrix composite material to form a composite ply comprising a fiducial of the plurality of fiducials. The composite ply comprising the fiducial is placed onto the layup tool. A position of the composite ply on the layup tool is determined based on a position of the fiducial relative to the layup tool.

Yet another embodiment of the present disclosure provides a method of locating a composite ply on a layup tool. The method determines if a tool surface of the layup tool is curved. Based on a determination that the tool surface is not curved, a ply shape is cut into a sheet of ceramic matrix composite material having a protective film. A fiducial is placed onto the protective film within the ply shape to form a composite ply comprising the fiducial. The composite ply comprising the fiducial is placed onto the layup tool. A position of the composite ply on the layup tool is determined based on a position of the fiducial relative to the layup tool.

A further embodiment of the present disclosure provides a ceramic matrix composite part. The ceramic matrix composite part comprises a plurality of ceramic matrix composite plies, and ink between two plies of the plurality of ceramic matrix composite plies.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of an aircraft in accordance with an illustrative embodiment;

FIG. 2 is an illustration of a block diagram of a manufacturing environment in accordance with an illustrative embodiment;

FIG. 3 is an illustration of a top view of fiducials printed on a sheet of ceramic matrix composite material in accordance with an illustrative embodiment;

FIG. 4 is an illustration of a top view of ply cut program in accordance with an illustrative embodiment;

FIG. 5 is an illustration of a top view of a cut sheet of ceramic matrix composite material with fiducials in accordance with an illustrative embodiment;

FIG. 6 is an illustration of a top view of a ply on a layup tool in accordance with an illustrative embodiment;

FIG. 7 is an illustration of a top view of a ply on a layup tool in accordance with an illustrative embodiment;

FIG. 8 is an illustration of an isometric view of a robotic end effector and a ply placed on a layup tool in accordance with an illustrative embodiment;

FIGS. 9A and 9B are a flowchart of a method of locating a composite ply on a layup tool in accordance with an illustrative embodiment;

FIG. 10 is a flowchart of a method of locating a composite ply on a layup tool in accordance with an illustrative embodiment;

FIG. 11 is a flowchart of a method of locating a composite ply on a layup tool in accordance with an illustrative embodiment;

FIG. 12 is an illustration of an aircraft manufacturing and service method in a form of a block diagram in accordance with an illustrative embodiment; and

FIG. 13 is an illustration of an aircraft in a form of a block diagram in which an illustrative embodiment may be implemented.

### DETAILED DESCRIPTION

The illustrative examples recognize and take into account several considerations. The illustrative examples recognize and take into account that currently overhead laser tracers are utilized to indicate where ply edges should be, and an operator visually confirms a location of the composite ply. The illustrative examples recognize and take into account that this process is a non-automated process. The illustrative examples recognize and take into account that the three-dimensional depth camera is used to confirm ply thickness. Automated accurate placement of CMC material during ply placement assembly.

The illustrative examples present a method of locating a composite ply on a layup tool. The illustrative examples place six degree of freedom (6DOF) or three degree of freedom (3DOF) fiducial markings on the protective film (that will be removed and disposed) or the composite material itself. The illustrative examples utilize a vision system to capture an image of the ply after placement and determine how far (translation and rotation) the fiducials are from nominal.

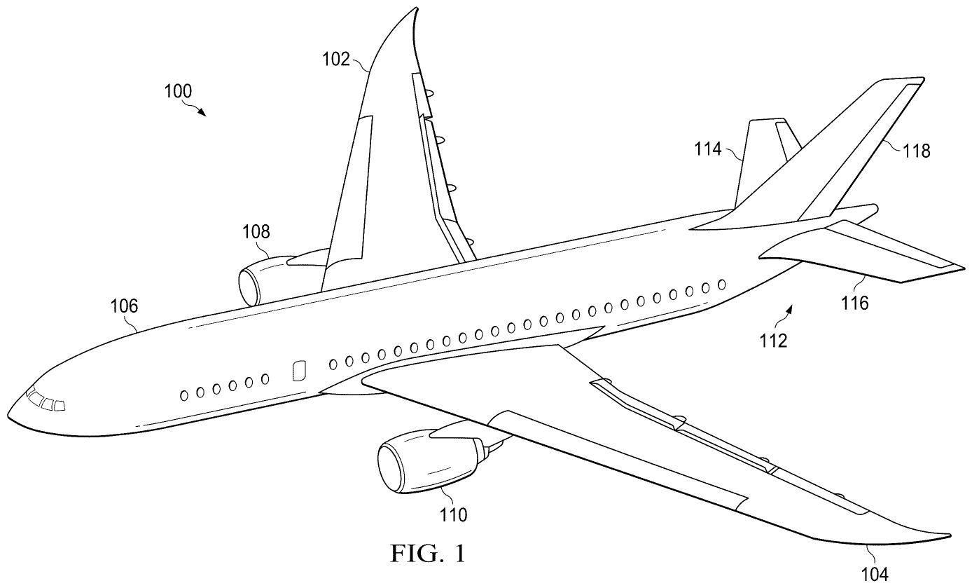

Turning now to FIG. 1, an illustration of an aircraft is depicted in accordance with an illustrative embodiment. Aircraft 100 has wing 102 and wing 104 attached to body 106. Aircraft 100 includes engine 108 attached to wing 102 and engine 110 attached to wing 104.

Body 106 has tail section 112. Horizontal stabilizer 114, horizontal stabilizer 116, and vertical stabilizer 118 are attached to tail section 112 of body 106.

Aircraft 100 is an example of an aircraft that can have composite parts formed using the illustrative examples. In some illustrative examples, a portion of at least one of wing 102, wing 104, or body 106 can be manufactured using the illustrative examples.

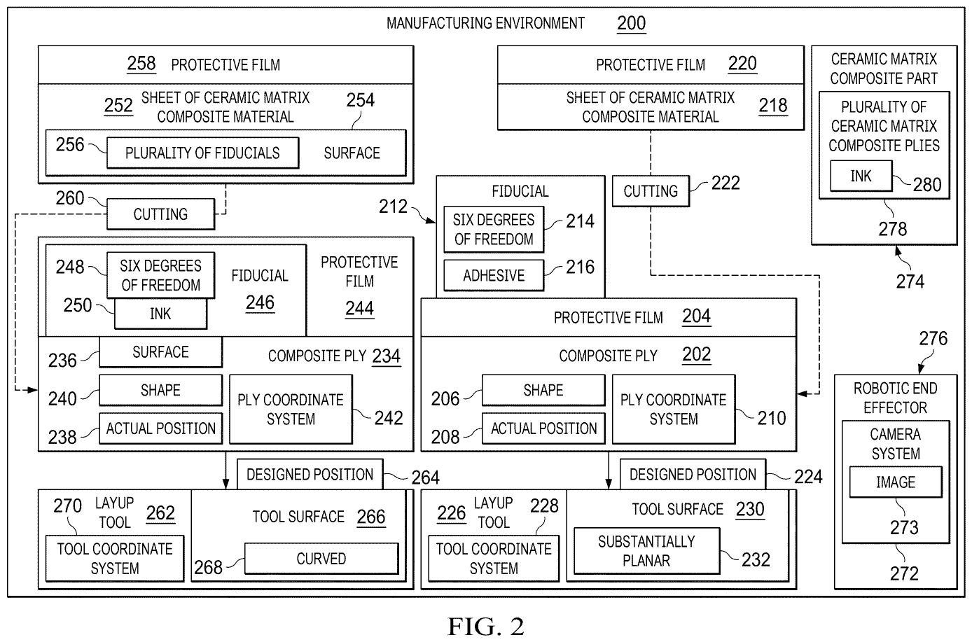

Turning now to FIG. 2, an illustration of a block diagram of a manufacturing environment is depicted in accordance with an illustrative embodiment. Composite parts of aircraft 100 can be formed in manufacturing environment 200. More specifically, composite plies are placed on layup tools, and actual locations of the composite plies are determined in manufacturing environment 200.

A composite part, such as ceramic matrix composite part 274, is built up of unique composite plies placed next to, and on top of other composite plies. There are tolerances associated with position of composite plies: overlaps and gaps between ply boundaries.

Each ply has a known coordinate system. In this illustrative example, composite ply 234 has ply coordinate system 242 and composite ply 202 has ply coordinate system 210.

Each layup tool has a known coordinate system. In this illustrative example, layup tool 262 has tool coordinate system 270 and layup tool 226 has tool coordinate system 228.

Based on a build plan, each ply is placed on a known position on the respective layup mold. A part build plan defines part geometry and the plies that make up the part. The part build plan also defines geometry of the plies, positions of the plies on the part, and the sequence of placement, etc. Based on a build plan, a ply is picked, placed, and compacted on a layup mold.

Composite ply 234 is placed on tool surface 266. The build plan has designed position 264 for composite ply 234 on layup tool 262. The build plan has designed position 224 for composite ply 202 on layup tool 226.

Comparing the nominal position of where the ply is to be placed in the build plan to the as built position can tell you if the ply border is in the correct place. The illustrative examples compare an actual position determined using a fiducial to the designed position. The illustrative examples compare actual position 238 of composite ply 234 to designed position 264. The illustrative examples compare actual position 208 of composite ply 202 to designed position 224. The illustrative examples also determine if gaps and overlaps meet tolerances. In some illustrative examples, boundary tolerance is +/0.05″.

In some illustrative examples, the fiducials can take the form of barcode grid patterns of a known size. As long as the fiducials are visible, the fiducials can be printed or adhered to a respective composite ply in any desirable fashion.

Camera system 272 can be used to take a picture of a respective fiducial. Camera system 272 can take the form of any desirable type of camera. In some illustrative examples, camera system 272 is a two dimensional camera.

Images taken using camera system 272 can present a position of a respective fiducial. Each fiducial has a six degree of freedom position. Each fiducial has X, Y, and Z translation as well as rotations around X, Y, and Z.

Unique identifiers are associated with each grid pattern in a respective fiducial. In general, the larger the fiducial is within the field of view of camera system 272, the better accuracy of the six degrees of freedom position.

To form a composite part, composite ply 234 is placed onto layup tool 262. Composite ply 234 comprises fiducial 246. In this illustrative example, fiducial 246 is visible on surface 236 of composite ply 234. In some illustrative examples, fiducial 246 is printed onto surface 236. In some illustrative examples, fiducial 246 is formed of ink 250. Ink 250 is compatible with the composite material of composite ply 234. In some illustrative examples, composite ply 234 is formed of a ceramic matrix composite material. Fiducial 246 has six degrees of freedom 248. In some illustrative examples, fiducial 246 is formed of material of composite ply 234.

A position of fiducial 246 of composite ply 234 is determined relative to layup tool 262.

Actual position 238 of composite ply 234 on layup tool 262 is determined. A difference between actual position 238 of composite ply and a designed position for the composite ply is determined.

In some illustrative examples, composite ply 234 is created by cutting 260 ply shape 240 into sheet of ceramic matrix composite material 252 having protective film 258. Cutting 260 ply shape 240 into sheet of ceramic matrix composite material 252 having plurality of fiducials 256 printed on surface 254 of ceramic matrix composite material forms composite ply 234.

In some illustrative examples, the manufacturer of sheet of ceramic matrix composite material 252 prints a random assortment of uniquely identifiable fiducials on a roll or sheet of CMC material. One example of a sheet of CMC material is sheet of ceramic matrix composite material 252. In some illustrative examples, rolls of CMC material are 3′ by 50′. Each respective fiducial on a sheet or roll is uniquely identifiable and has an associated coordinate system.

Composite ply 234 is removed from sheet of ceramic matrix composite material 252 after cutting 260. In some illustrative examples, additional composite plies with a same layup as composite ply 234 can be cut from sheet of ceramic matrix composite material 252 later.

In some illustrative examples, placing composite ply 234 onto layup tool 262 comprises placing composite ply 234 onto curved 268 tool surface 266. In some illustrative examples, composite ply 234 with fiducial 246 on composite ply 234 is desirable on curved tool surfaces. Fiducial 246 is not displaced by placement on a curved surface. Fiducial 246 is still identifiable on a curved surface. In some illustrative examples, a position of protective film 244 changes on composite ply 234 as composite ply 234 is placed on curved 268 tool surface 266.

To form a composite part, composite ply 234 and any other composite plies on layup tool 262 are cured to form the composite part. During curing of composite ply 234, ink 250 of fiducial 246 is heated. In some illustrative examples, when ink 250 is heated, volatiles of fiducial 246 are evacuated during curing of composite ply 234. In other illustrative examples, ink 250 does not evacuate during curing. In some illustrative examples, ink 250 remains in the completed composite part, such as ceramic matrix composite part 274.

Ceramic matrix composite part 274 comprises plurality of ceramic matrix composite plies 278 and ink 280 between two plies of plurality of ceramic matrix composite plies 278. In some illustrative examples, one of the two plies is a partial ply.

In some illustrative examples, ink 280 is arranged in a fiducial with six degrees of freedom, such as fiducial 246 with six degrees of freedom 248. In other illustrative examples, ink 280 can be dispersed during curing and may no longer resemble a fiducial.

In some illustrative examples, fiducial 212 is present over protective film 204 on composite ply 202. In some illustrative examples, composite ply 202 is created by cutting 222 ply shape 206 into sheet of ceramic matrix composite material 218 having protective film 220.

Fiducial 212 is placed onto protective film 204 in ply shape 206. In some illustrative examples, placing fiducial 212 onto protective film 204 comprises printing fiducial 212 onto protective film 204. In other illustrative examples, placing fiducial 212 onto protective film 204 comprises adhering fiducial 212 onto protective film 204. In these illustrative examples, adhesive 216 adheres fiducial 212 to protective film 204. Fiducial 212 comprises six degrees of freedom 214.

In some illustrative examples, placing composite ply 202 onto layup tool 226 comprises placing composite ply 202 onto substantially planar 232 tool surface 230. By placing composite ply 202 onto substantially planar 232 tool surface 230, protective film 204 does not undesirably displace relative to composite ply 202.

After placing composite ply 202 onto layup tool 226, camera system 272 captures an image, image 273 of fiducial 212 on layup tool 226. In some illustrative examples, determining the position of fiducial 212 of composite ply 202 relative to layup tool 226 comprises determining a location of fiducial 212 in image 273. After determining the position of composite ply 202 on layup tool 226, protective film 204 with fiducial 212 is removed.

The illustrative examples determine whether the difference between the between the actual position and the designed position is within tolerance. The illustrative examples generate an alert when the difference is not within tolerance. For example, if a difference between actual position 208 and designed position 224 is not within tolerance, the illustrative examples generate an alert. The alert can take any desirable form. In some illustrative examples, no further composite material will be placed onto a respective tool until the out of tolerance difference is resolved.

The illustration of manufacturing environment 200 in FIG. 2 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, additional composite plies (not depicted) can be placed onto layup tool 262 prior to placing composite ply 234. Additional composite plies (not depicted) can be placed onto composite ply 234 after placement of composite ply 234. Further, composite ply 234 could instead be placed on a planar or substantially planar tool surface.

In some illustrative examples, the six degree of freedom position of each ply relative to layup mold is stored as part of the build plan in a lookup table.

Although the illustrative examples above discuss ceramic matrix composite materials, in other illustrative examples the composite materials can comprise other materials. In some illustrative examples, the composite materials can comprise polymer matrix composites. In these illustrative examples, at least one of composite ply 202 or composite ply 234 can comprise a polymer matrix composite. In some of these illustrative examples, at least one of composite ply 202 or composite ply 234 is cut from a sheet of polymer matrix composite material instead of a sheet of ceramic matrix composite material. In these illustrative examples, composite ply 202 or composite ply 234 forms a polymer matrix composite part with a plurality of polymer matrix composite plies instead of ceramic matrix composite part 274.

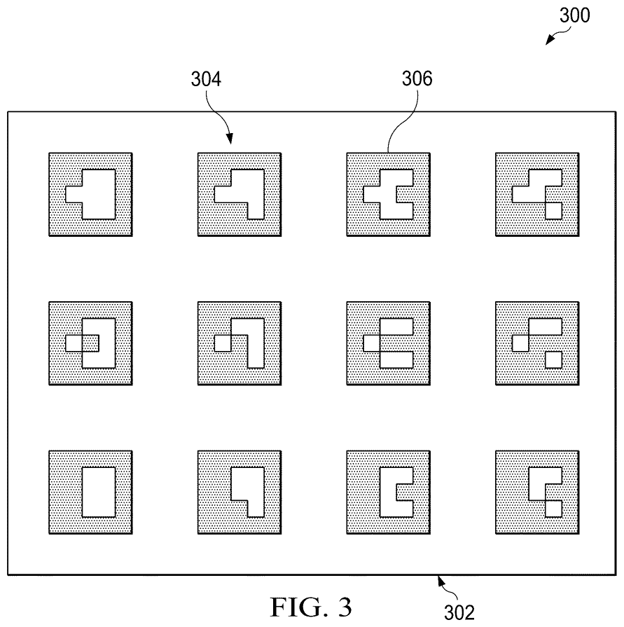

Turning now to FIG. 3, an illustration of a top view of fiducials printed on a sheet of composite material is depicted in accordance with an illustrative embodiment. Sheet of composite material 302 can be used to manufacture a composite part of aircraft 100 of FIG. 1. Sheet of composite material 302 can be a physical implementation of sheet of ceramic matrix composite material 252 of FIG. 2. Sheet of composite material 302 can take the form of a sheet of ceramic matrix composite material. Sheet of composite material can take the form of a sheet of polymer matrix composite material.

In view 300, plurality of fiducials 304 is present on sheet of composite material 302. Plurality of fiducials 304 is formed of any desirable material compatible with sheet of composite material 302. In some illustrative examples, plurality of fiducials 304 is printed onto sheet of composite material 302 using a compatible ink. In some illustrative examples, the ink is configured to remain within a completed composite part. In some illustrative examples, the ink is configured to be released with other volatiles during curing of sheet of composite material 302.

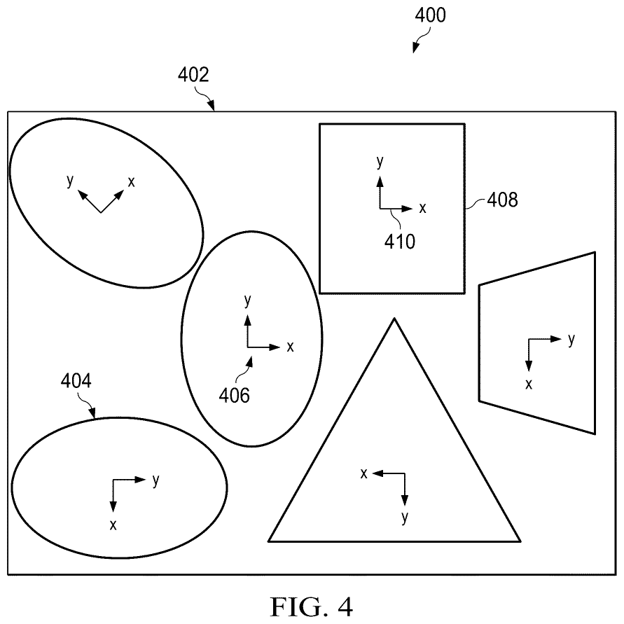

Turning now to FIG. 4, an illustration of a top view of ply cut program is depicted in accordance with an illustrative embodiment. Ply cut program 400 can be used in manufacturing a composite part of aircraft 100 of FIG. 1. Ply cut program 400 can be used in cutting 260 of FIG. 2. Ply cut program 400 can be used to cut sheet of composite material 302 of FIG. 3.

Ply cut program 400 comprises plurality of cuts 404 and plurality of coordinate systems 406. Plurality of cuts 404 is configured to cut a plurality of plies. Each ply of the plurality of plies has its own respective coordinate system of plurality of coordinate systems 406.

Ply cut 408 of plurality of cuts 404 can be used to cut a ply having fiducial 306 of sheet of composite material 302. Ply cut 408 has coordinate system 410 of plurality of coordinate systems 406.

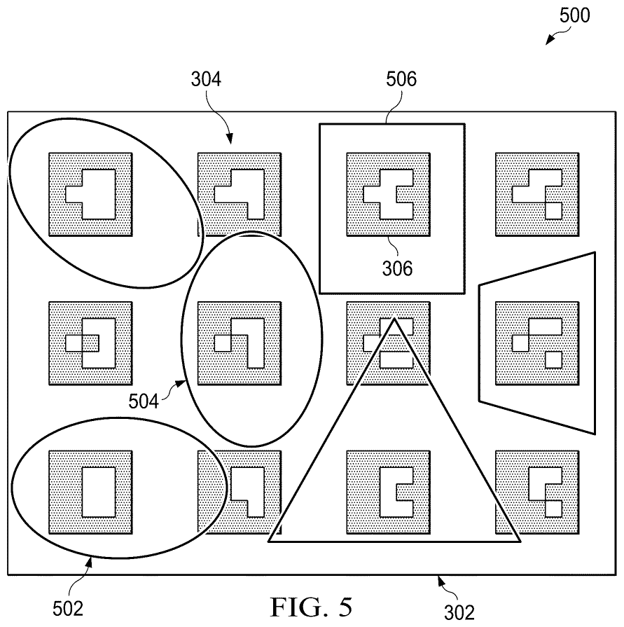

Turning now to FIG. 5, an illustration of a top view of a cut sheet of composite material with fiducials is depicted in accordance with an illustrative embodiment. View 500 is a view of sheet of composite material 302 after being cut using ply cut program 400 of FIG. 4.

In view 500, plurality of cuts 502 have been made into sheet of composite material 302 to form plurality of plies 504. Ply 506 of plurality of plies 504 comprises fiducial 306. Fiducial 306 can be used for verifying location of ply 506 on a layup tool, mandrel, or any other desirable type of tool.

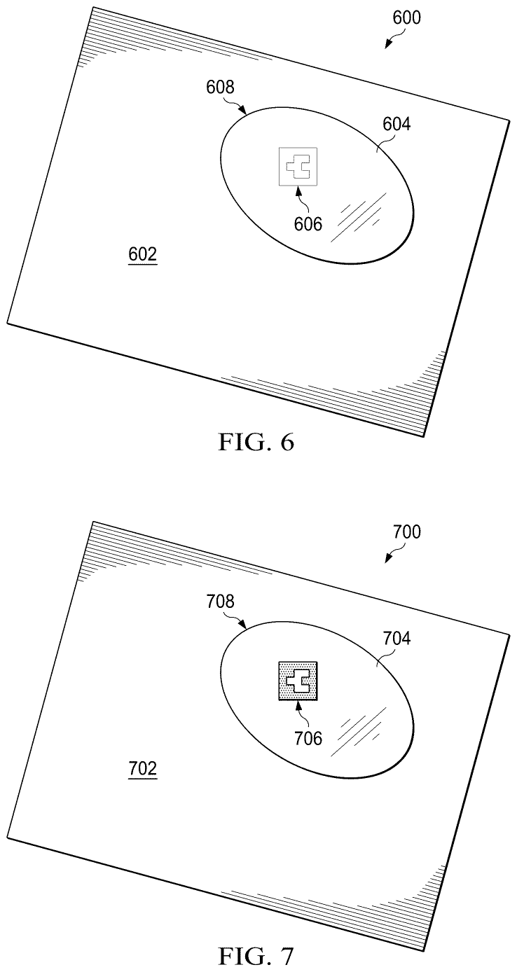

Turning now to FIG. 6, an illustration of a top view of a ply on a layup tool is depicted in accordance with an illustrative embodiment. View 600 is a view of composite ply 604 on layup tool 602. Composite ply 604 is a physical implementation of composite ply 234 of FIG. 2. Composite ply 604 can be used to form a portion of aircraft 100 of FIG. 1. Composite ply 604 can be an example of a ply cut from sheet of composite material 302 of FIG. 3. Composite ply 604 can be an example of a ply cut using ply cut program 400 of FIG. 4.

Composite ply 604 comprises fiducial 606. Fiducial 606 is printed directly on the composite material of composite ply 604. In this illustrative example, fiducial 606 is positioned below a protective film. Fiducial 606 can be used to verify position 608 of composite ply 604 on layup tool 602.

Composite ply 604 comprises any desirable composite material. In some illustrative examples, composite ply 604 comprises one of a polymer matrix composite material or a ceramic matrix composite material.

Turning now to FIG. 7, an illustration of a top view of a ply on a layup tool is depicted in accordance with an illustrative embodiment. View 700 is a view of composite ply 704 on layup tool 702. Composite ply 704 is a physical implementation of composite ply 234 of FIG. 2. Composite ply 704 can be used to form a portion of aircraft 100 of FIG. 1. Composite ply 704 can be an example of a ply cut using ply cut program 400 of FIG. 4.

Composite ply 704 comprises fiducial 706. Fiducial 706 is positioned on the protective film of composite ply 704. In some illustrative examples, fiducial 706 can be adhered to the protective film. In some illustrative examples, fiducial 706 can be printed onto the protective film. Fiducial 706 can be used to verify position 708 of composite ply 704 on layup tool 702.

Composite ply 704 comprises any desirable composite material. In some illustrative examples, composite ply 704 comprises one of a polymer matrix composite material or a ceramic matrix composite material.

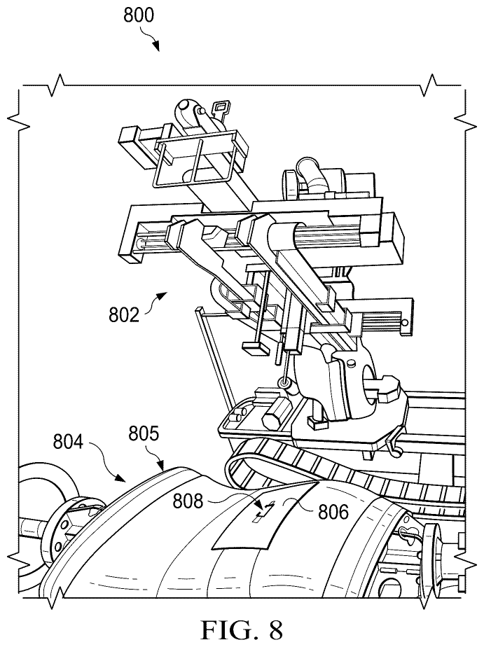

Turning now to FIG. 8, an illustration of an isometric view of a robotic end effector and a ply placed on a layup tool is depicted in accordance with an illustrative embodiment. View 800 is a view within a manufacturing environment for placement and verification of a location of composite plies. Robotic end effector 802 within manufacturing environment is used to place composite ply 806 having fiducial 808 onto layup tool 804. In this illustrative example, layup tool 804 has curvature 805. It is more desirable to utilize composite plies with fiducials printed directly on the composite material for layup tool 804 having curvature 805. However, in this illustrative example, fiducial 808 is adhered to a protective film of composite ply 806.

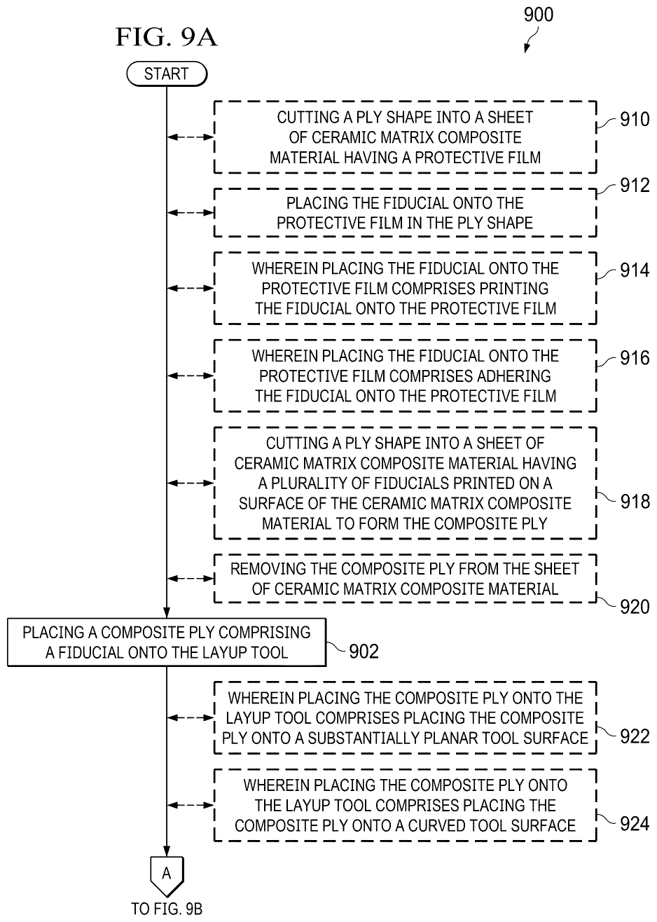

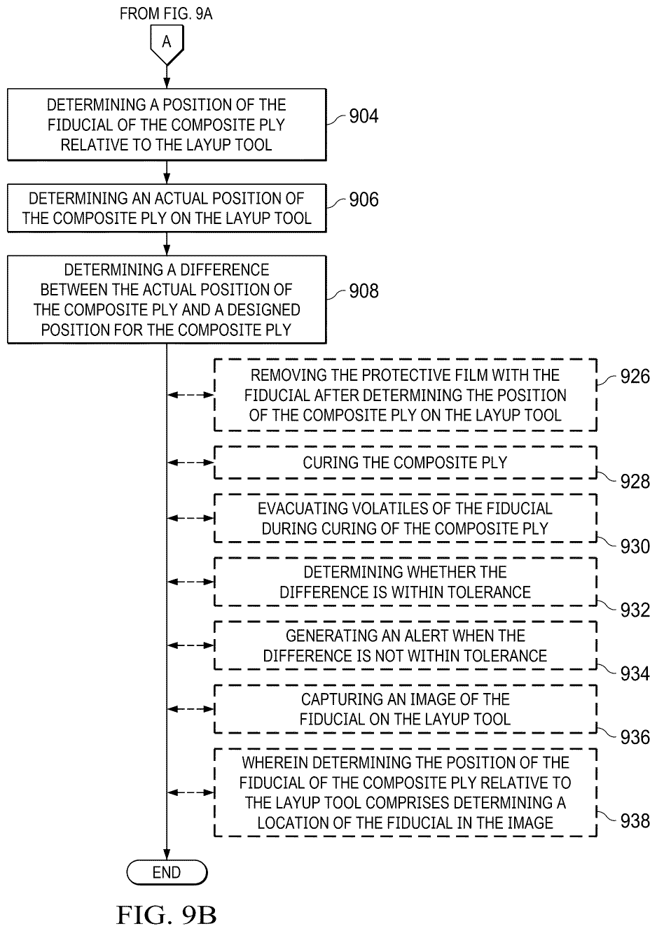

Turning now to FIGS. 9A and 9B, a flowchart of a method of locating a composite ply on a layup tool is depicted in accordance with an illustrative embodiment. Method 900 can be used in manufacturing a component of aircraft 100 of FIG. 1. Method 900 can be used to locate composite ply 234 and composite ply 202 of FIG. 2. Method 900 can be used with Sheet of composite material 302 of FIG. 3. Method 900 can be performed with a composite ply cut using ply cut program 400 of FIG. 4. Method 900 can be performed with plurality of plies 504 of FIG. 5. Method 900 can be performed to locate composite ply 604 of FIG. 6. Method 900 can be performed to locate composite ply 704 of FIG. 7. Method 900 can be performed using robotic end effector 802 to locate composite ply 806 of FIG. 8.

Method 900 places a composite ply comprising a fiducial onto the layup tool (operation 902). Method 900 determines a position of the fiducial of the composite ply relative to the layup tool (operation 904). Method 900 determines an actual position of the composite ply on the layup tool (operation 906). Method 900 determines a difference between the actual position of the composite ply and a designed position for the composite ply (operation 908). Afterwards, method 900 terminates.

In some illustrative examples, method 900 cuts a ply shape into a sheet of ceramic matrix composite material having a protective film (operation 910). In some illustrative examples, method 900 places the fiducial onto the protective film in the ply shape (operation 912).

In some illustrative examples, placing the fiducial onto the protective film comprises printing the fiducial onto the protective film (operation 914). In some illustrative examples, placing the fiducial onto the protective film comprises adhering the fiducial onto the protective film (operation 916).

In some illustrative examples, method 900 cuts a ply shape into a sheet of ceramic matrix composite material having a plurality of fiducials printed on a surface of the ceramic matrix composite material to form the composite ply (operation 918); and

In some illustrative examples, method 900 removes the composite ply from the sheet of ceramic matrix composite material (operation 920). In some illustrative examples, placing the composite ply onto the layup tool comprises placing the composite ply onto a substantially planar tool surface (922).

In some illustrative examples, placing the composite ply onto the layup tool comprises placing the composite ply onto a curved tool surface (operation 924).

In some illustrative examples, method 900 removes the protective film with the fiducial after determining the position of the composite ply on the layup tool (operation 926).

In some illustrative examples, method 900 cures the composite ply (operation 928).

In some illustrative examples, method 900 evacuates volatiles of the fiducial during curing of the composite ply (operation 930).

In some illustrative examples, method 900 determines whether the difference is within tolerance (operation 932).

In some illustrative examples, method 900 generates an alert when the difference is not within tolerance (operation 934).

In some illustrative examples, method 900 captures an image of the fiducial on the layup tool (operation 936).

In some illustrative examples, determining the position of the fiducial of the composite ply relative to the layup tool comprises determining a location of the fiducial in the image (operation 938).

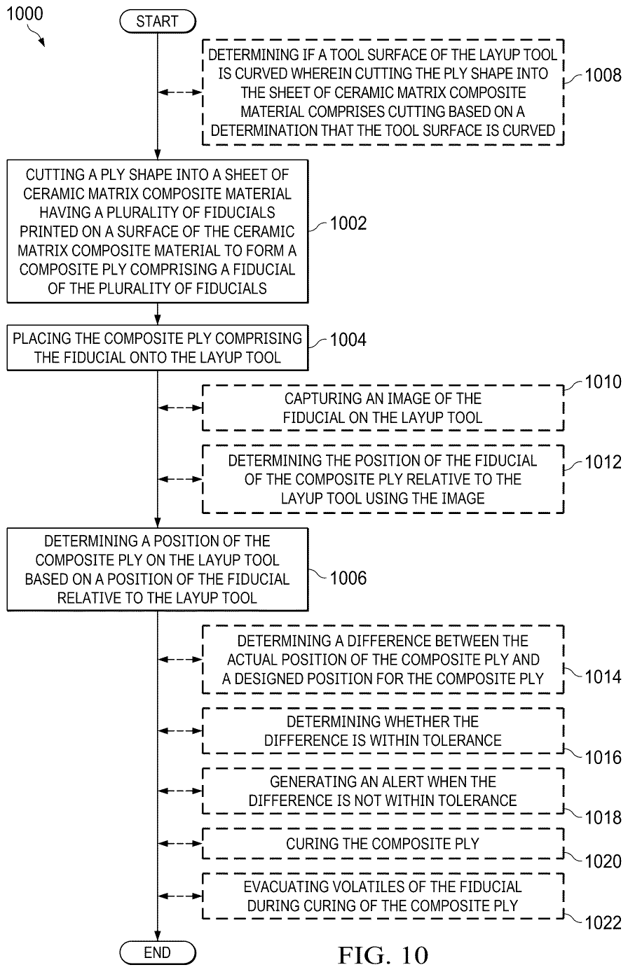

Turning now to FIG. 10, a flowchart of a method of locating a composite ply on a layup tool is depicted in accordance with an illustrative embodiment. Method 1000 can be used in manufacturing a component of aircraft 100 of FIG. 1. Method 1000 can be used to locate composite ply 234 and composite ply 202 of FIG. 2. Method 1000 can be used with Sheet of composite material 302 of FIG. 3. Method 1000 can be performed with a composite ply cut using ply cut program 400 of FIG. 4. Method 1000 can be performed with plurality of plies 504 of FIG. 5. Method 1000 can be performed to locate composite ply 604 of FIG. 6. Method 1000 can be performed to locate composite ply 704 of FIG. 7. Method 1000 can be performed using robotic end effector 802 to locate composite ply 806 of FIG. 8.

Method 1000 cuts a ply shape into a sheet of ceramic matrix composite material having a plurality of fiducials printed on a surface of the ceramic matrix composite material to form a composite ply comprising a fiducial of the plurality of fiducials (operation 1002). Method 1000 places the composite ply comprising the fiducial onto the layup tool (operation 1004). Method 1000 determines a position of the composite ply on the layup tool based on a position of the fiducial relative to the layup tool (operation 1006). Afterwards, method 1000 terminates.

Although method 1000 is discussing ceramic matrix composite material, in other illustrative examples the composite material sheet can comprise any desirable composite material. In some illustrative examples, the composite ply comprises a polymer matrix composite material. In some illustrative examples, the method cuts a ply shape into a sheet of polymer matrix composite material having a plurality of fiducials printed on a surface of the polymer matrix composite material to form a composite ply comprising a fiducial of the plurality of fiducials.

In some illustrative examples, method 1000 determines if a tool surface of the layup tool is curved, wherein cutting the ply shape into the sheet of ceramic matrix composite material comprises cutting based on a determination that the tool surface is curved (operation 1008). In some illustrative examples, when the layup tool is curved, it is desirable to have the fiducial located on the composite material.

In some illustrative examples, method 1000 captures an image of the fiducial on the layup tool (operation 1010). In some illustrative examples, method 1000 determines the position of the fiducial of the composite ply relative to the layup tool using the image (operation 1012).

In some illustrative examples, method 1000 determines a difference between the actual position of the composite ply and a designed position for the composite ply (operation 1014). In some illustrative examples, method 1000 determines whether the difference is within tolerance (operation 1016). In some illustrative examples, method 1000 generates an alert when the difference is not within tolerance (operation 1018).

In some illustrative examples, method 1000 cures the composite ply (operation 1020). In some illustrative examples, method 1000 evacuates volatiles of the fiducial during curing of the composite ply (operation 1022).

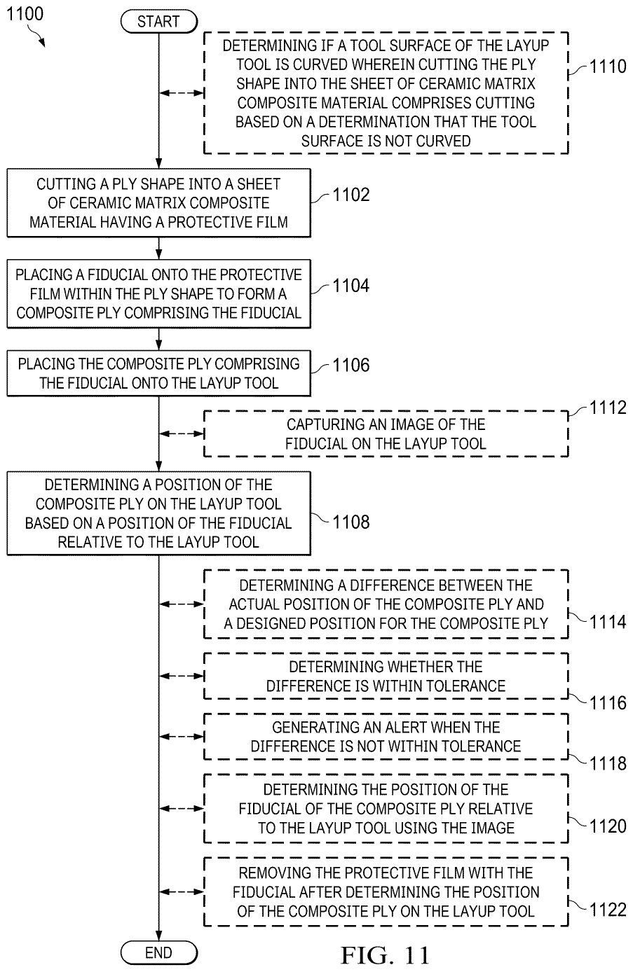

Turning now to FIG. 11, a flowchart of a method of locating a composite ply on a layup tool is depicted in accordance with an illustrative embodiment. Method 1100 can be used in manufacturing a component of aircraft 100 of FIG. 1. Method 1100 can be used to locate composite ply 234 and composite ply 202 of FIG. 2. Method 1100 can be used with Sheet of composite material 302 of FIG. 3. Method 1100 can be performed with a composite ply cut using ply cut program 400 of FIG. 4. Method 1100 can be performed with plurality of plies 504 of FIG. 5. Method 1100 can be performed to locate composite ply 604 of FIG. 6. Method 1100 can be performed to locate composite ply 704 of FIG. 7. Method 1100 can be performed using robotic end effector 802 to locate composite ply 806 of FIG. 8.

Method 1100 cuts a ply shape into a sheet of ceramic matrix composite material having a protective film (operation 1102). Method 1100 places a fiducial onto the protective film within the ply shape to form a composite ply comprising the fiducial (operation 1104). Method 1100 places the composite ply comprising the fiducial onto the layup tool (operation 1106). Method 1100 determines a position of the composite ply on the layup tool based on a position of the fiducial relative to the layup tool (operation 1108). Afterwards, method 1100 terminates.

Although method 1100 is discussing ceramic matrix composite material, in other illustrative examples the composite material sheet can comprise any desirable composite material. In some illustrative examples, the composite ply comprises a polymer matrix composite material. In some illustrative examples, the method cuts a ply shape into a sheet of polymer matrix composite material having a protective film.

Method 1100 determines if a tool surface of the layup tool is curved, wherein cutting a ply shape into a sheet of ceramic matrix composite material comprises cutting based on a determination that the tool surface is not curved, (operation 1110). In some illustrative examples, method 1100 captures an image of the fiducial on the layup tool (operation 1112). In some illustrative examples, the image of the fiducial can be captured using a same robotic end effector that placed the composite ply onto the layup tool. In some illustrative examples, a camera system is attached to a robotic end effector configured to place and image the composite ply.

In some illustrative examples, method 1100 determines a difference between the actual position of the composite ply and a designed position for the composite ply (operation 1114). The actual position can be determined from the image. The designed position is determined from at least one of a build plan or a three dimensional model for the part.

In some illustrative examples, method 1100 determines whether the difference is within tolerance (operation 1116). In some illustrative examples, method 1100 generates an alert when the difference is not within tolerance (operation 1118). In some illustrative examples, the layup is paused until a difference between the designed and actual location of the composite ply is corrected.

In some illustrative examples, method 1100 determines the position of the fiducial of the composite ply relative to the layup tool using the image (operation 1120). In some illustrative examples, method 1100 removes the protective film with the fiducial after determining the position of the composite ply on the layup tool (operation 1122).

As used herein, the phrase “at least one of,” when used with a list of items, means different combinations of one or more of the listed items may be used and only one of each item in the list may be needed. For example, “at least one of item A, item B, or item C” may include, without limitation, item A, item A and item B, or item B. This example also may include item A, item B, and item C, or item B and item C. Of course, any combinations of these items may be present. In other examples, “at least one of” may be, for example, without limitation, two of item A; one of item B; and ten of item C; four of item B and seven of item C; or other suitable combinations. The item may be a particular object, thing, or a category. In other words, at least one of means any combination items and number of items may be used from the list but not all of the items in the list are required.

As used herein, “a number of,” when used with reference to items means one or more items.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step.

In some alternative implementations of an illustrative embodiment, the function or functions noted in the blocks may occur out of the order noted in the figures. For example, in some cases, two blocks shown in succession may be executed substantially concurrently, or the blocks may sometimes be performed in the reverse order, depending upon the functionality involved. Also, other blocks may be added in addition to the illustrated blocks in a flowchart or block diagram. Some blocks may be optional. For example, operation 910 through operation 938 may be optional. As another example, operation 1010 through operation 1022 may be optional. As another example, operation 1112 through operation 1122 may be optional.

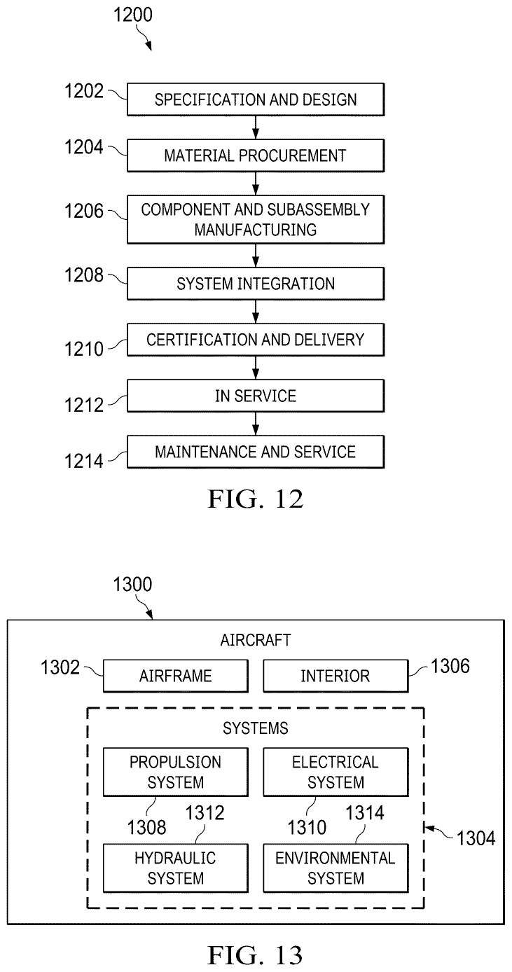

Illustrative embodiments of the present disclosure may be described in the context of aircraft manufacturing and service method 1200 as shown in FIG. 12 and aircraft 1300 as shown in FIG. 13. Turning first to FIG. 12, an illustration of an aircraft manufacturing and service method in a form of a block diagram is depicted in accordance with an illustrative embodiment. During pre-production, aircraft manufacturing and service method 1200 may include specification and design 1202 of aircraft 1300 in FIG. 13 and material procurement 1204.

During production, component and subassembly manufacturing 1206 and system integration 1208 of aircraft 1300 takes place. Thereafter, aircraft 1300 may go through certification and delivery 1210 in order to be placed in service 1212. While in service 1212 by a customer, aircraft 1300 is scheduled for routine maintenance and service 1214, which may include modification, reconfiguration, refurbishment, or other maintenance and service.

Each of the processes of aircraft manufacturing and service method 1200 may be performed or carried out by a system integrator, a third party, and/or an operator. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 13, an illustration of an aircraft in a form of a block diagram is depicted in which an illustrative embodiment may be implemented. In this example, aircraft 1300 is produced by aircraft manufacturing and service method 1200 of FIG. 12 and may include airframe 1302 with plurality of systems 1304 and interior 1306. Examples of systems 1304 include one or more of propulsion system 1308, electrical system 1310, hydraulic system 1312, and environmental system 1314. Any number of other systems may be included.

Apparatuses and methods embodied herein may be employed during at least one of the stages of aircraft manufacturing and service method 1200. One or more illustrative embodiments may be manufactured or used during at least one of component and subassembly manufacturing 1206, system integration 1208, in service 1212, or maintenance and service 1214 of FIG. 12.

The illustrative examples present materials and methods for accurately locating composite plies. Parts made of fabric based CMC material are performed by building up multiple layers of material on top of a layup mandrel or tool mold. A composite part is built up of unique composite plies placed next to, and on top of other composite plies. Tolerances are associated with the position of composite plies. In cases where the part edges are not trimmed, the edges of the plies need to be positioned precisely. Butt splices have overlap and gaps tolerances, overlapped plies have different tolerances, often within 0.050″ of nominal.

Tolerances are associated with overlaps and gaps between ply boundaries. Each ply has a known coordinate system. The layup mold has a known coordinate system.

Based on a build plan, the composite ply is placed on a known position on the layup mold. Comparing the nominal position of where the composite ply is supposed to be placed to the as-built position can be used to determine if the ply border is in the correct place, and if gaps and overlaps meet tolerances.

In the illustrative examples, a fiducial is placed upon the backing material. When placed on a relatively flat surface, the fiducial on the backing material can be used to locate the ply prior to removing the backing. Each fiducial can be unique to the roll of material or unique to the cut material.

In the illustrative examples, when placed upon a more contoured surface, a fiducial associated with the composite material can be used for ply placement. Each fiducial can be unique to the roll of material or unique to the cut material. A part is built up of unique plies placed next to, and on top of other plies. Each ply has a known coordinate system. The layup mold has a known coordinate system. Based on a build plan, the ply is placed on a known position on the layup mold. Comparing the nominal position of where the ply is supposed to be placed to the as-built position can tell you if the ply border is in the correct place: and if gaps and overlaps meet tolerances.

A large number of uniquely identifiable six degrees of freedom (6DOF) fiducials can be printed on the raw CMC material before the slurry and protective films are added. The positions of the 6DOF fiducials on the roll of raw material can be anywhere on the roll of material. A ply cut program for each of the plies cuts unique ply shapes from the roll of raw material with the fiducials.

In the illustrative examples, a vision system captures an image of 6DOF fiducial and unique ID within boundaries of each unique ply. In the illustrative examples, a position of a 6DOF fiducial within each ply is derived relative to a coordinate system of the individual ply. After a ply is placed on layup mandrel/part mold the position of the ply relative to the layup mandrel/part mold is derived using the vision system. In the illustrative examples, the ply boundaries can be calculated relative to the nominal positions.

The description of the different illustrative embodiments has been presented for purposes of illustration and description, and is not intended to be exhaustive or limited to the embodiments in the form disclosed. Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

1. A method of locating a composite ply on a layup tool comprising:
placing a composite ply comprising a fiducial onto the layup tool;
determining a position of the fiducial of the composite ply relative to the layup tool;
determining an actual position of the composite ply on the layup tool; and
determining a difference between the actual position of the composite ply and a designed position for the composite ply.

2. The method of claim 1 further comprising:
cutting a ply shape into a sheet of ceramic matrix composite material having a protective film; and
placing the fiducial onto the protective film in the ply shape.

3. The method of claim 2, wherein placing the fiducial onto the protective film comprises printing the fiducial onto the protective film.

4. The method of claim 2, wherein placing the fiducial onto the protective film comprises adhering the fiducial onto the protective film.

5. The method of claim 2 further comprising:
removing the protective film with the fiducial after determining the position of the composite ply on the layup tool.

6. The method of claim 2, wherein placing the composite ply onto the layup tool comprises placing the composite ply onto a substantially planar tool surface.

7. The method of claim 1 further comprising:
cutting a ply shape into a sheet of ceramic matrix composite material having a plurality of fiducials printed on a surface of the ceramic matrix composite material to form the composite ply; and
removing the composite ply from the sheet of ceramic matrix composite material.

8. The method of claim 7, wherein placing the composite ply onto the layup tool comprises placing the composite ply onto a curved tool surface.

9. The method of claim 7 further comprising:
curing the composite ply; and
evacuating volatiles of the fiducial during curing of the composite ply.

10. The method of claim 1 further comprising:
determining whether the difference is within tolerance; and
generating an alert when the difference is not within tolerance.

11. The method of claim 1 further comprising:
capturing an image of the fiducial on the layup tool; and
wherein determining the position of the fiducial of the composite ply relative to the layup tool comprises determining a location of the fiducial in the image.

12. A method of locating a composite ply on a layup tool comprising:
cutting a ply shape into a sheet of ceramic matrix composite material having a plurality of fiducials printed on a surface of the ceramic matrix composite material to form a composite ply comprising a fiducial of the plurality of fiducials;
placing the composite ply comprising the fiducial onto the layup tool; and
determining a position of the composite ply on the layup tool based on a position of the fiducial relative to the layup tool.

13. The method of claim 12 further comprising:
determining if a tool surface of the layup tool is curved, wherein cutting the ply shape into the sheet of ceramic matrix composite material comprises cutting based on a determination that the tool surface is curved.

14. The method of claim 12 further comprising:
determining a difference between the actual position of the composite ply and a designed position for the composite ply.

15. The method of claim 14 further comprising:
determining whether the difference is within tolerance; and
generating an alert when the difference is not within tolerance.

16. The method of claim 12 further comprising:
capturing an image of the fiducial on the layup tool; and
determining the position of the fiducial of the composite ply relative to the layup tool using the image.

17. The method of claim 12 further comprising:
curing the composite ply; and
evacuating volatiles of the fiducial during curing of the composite ply.

18. A method of locating a composite ply on a layup tool comprising:
cutting a ply shape into a sheet of ceramic matrix composite material having a protective film;
placing a fiducial onto the protective film within the ply shape to form a composite ply comprising the fiducial;
placing the composite ply comprising the fiducial onto the layup tool; and
determining a position of the composite ply on the layup tool based on a position of the fiducial relative to the layup tool.

19. The method of claim 18 further comprising:
determining if a tool surface of the layup tool is curved, wherein cutting a ply shape into a sheet of ceramic matrix composite material comprises cutting based on a determination that the tool surface is not curved.

20. The method of claim 18 further comprising:
determining a difference between the actual position of the composite ply and a designed position for the composite ply.

21. The method of claim 20 further comprising:
determining whether the difference is within tolerance; and
generating an alert when the difference is not within tolerance.

22. (canceled)

23. The method of claim 18 further comprising:
removing the protective film with the fiducial after determining the position of the composite ply on the layup tool.

24. A ceramic matrix composite part comprising:
a plurality of ceramic matrix composite plies; and
ink between two plies of the plurality of ceramic matrix composite plies.

25. The ceramic matrix composite part of claim 24, wherein the ink is arranged in a fiducial with six degrees of freedom.

26. The ceramic matrix composite part of claim 24, wherein one of the two plies is a partial ply.
